(19) United States
(12) Patent Application Publication
(10) Pub. No.: US 2024/0292339 A1
(43) Pub. Date: Aug. 29, 2024

(54) POWER CONTROL STATE RESET FOR UNIFIED TCI STATES

(71) Applicant: QUALCOMM Incorporated, San Diego, CA (US)

(72) Inventors: Yan ZHOU, San Diego, CA (US); Fang YUAN, Beijing (CN); Chun-Hao HSU, San Jose, CA (US); Tao LUO, San Diego, CA (US); Junyi LI, Fairless Hills, PA (US)

(21) Appl. No.: 18/571,696

(22) PCT Filed: Aug. 6, 2021
(86) PCT No.: PCT/CN2021/111164

§ 371 Date: Dec. 18, 2023

(51) Int. Cl. H04W 52/14

(52) U.S. Cl. CPC H04W 52/146

(57) ABSTRACT

Aspects presented herein relate to methods and devices for wireless communication including an apparatus, e.g., a UE and/or a base station. The apparatus may receive, from a base station, an indication of at least one of an update to one or more PC parameters, an update to an UL beam indication, or an update to the one or more PC parameters associated with the UL beam indication. The apparatus may also configure, based on the indication, a PC adjustment state for an active UL BWP of a CC. The apparatus may also transmit, to the base station, an uplink channel or an uplink signal based on the configured PC adjustment state for the active UL BWP of the CC.

### TECHNICAL FIELD

The present disclosure relates generally to communication systems, and more particularly, to power control (PC) states in wireless communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive, from a base station, an indication of at least one of an update to one or more power control (PC) parameters, an update to an uplink (UL) beam indication, or an update to the one or more PC parameters associated with the UL beam indication. The apparatus may also configure, based on the indication, a PC adjustment state for an active UL bandwidth part (BWP) of a component carrier (CC). The apparatus may also maintain the PC adjustment state for the active UL BWP of the CC; reset the PC adjustment state for the active UL BWP of the CC; or determine whether to reset the PC adjustment state for the active UL BWP of the CC. Additionally, the apparatus may reset the PC adjustment state for the active UL BWP of the CC when the one or more PC parameters associated with the UL common TCI state or the joint UL and DL common TCI state are updated. The apparatus may also transmit, to the base station, an uplink channel or an uplink signal based on the configured PC adjustment state for the active UL BWP of the CC.

In another aspect of the disclosure, a method, a computer-readable medium, and an apparatus are provided. The apparatus may be a base station. The apparatus may transmit, to a user equipment (UE), an indication of at least one of an update to one or more power control (PC) parameters, an update to an uplink (UL) beam indication, or an update to the one or more PC parameters associated with the UL beam indication. The apparatus may also receive, from the UE based on the indication, an uplink channel or an uplink signal based on a power control (PC) adjustment state for an active UL bandwidth part (BWP) of a component carrier (CC).

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example medium access control (MAC) control element (MAC-CE).

FIG. 5 is a diagram illustrating example communication between a UE and a base station.

FIG. 6 is a flowchart of a method of wireless communication.

FIG. 7 is a flowchart of a method of wireless communication.

FIG. 8 is a flowchart of a method of wireless communication.

FIG. 9 is a diagram illustrating an example of a hardware implementation for an example apparatus.

FIG. 10 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

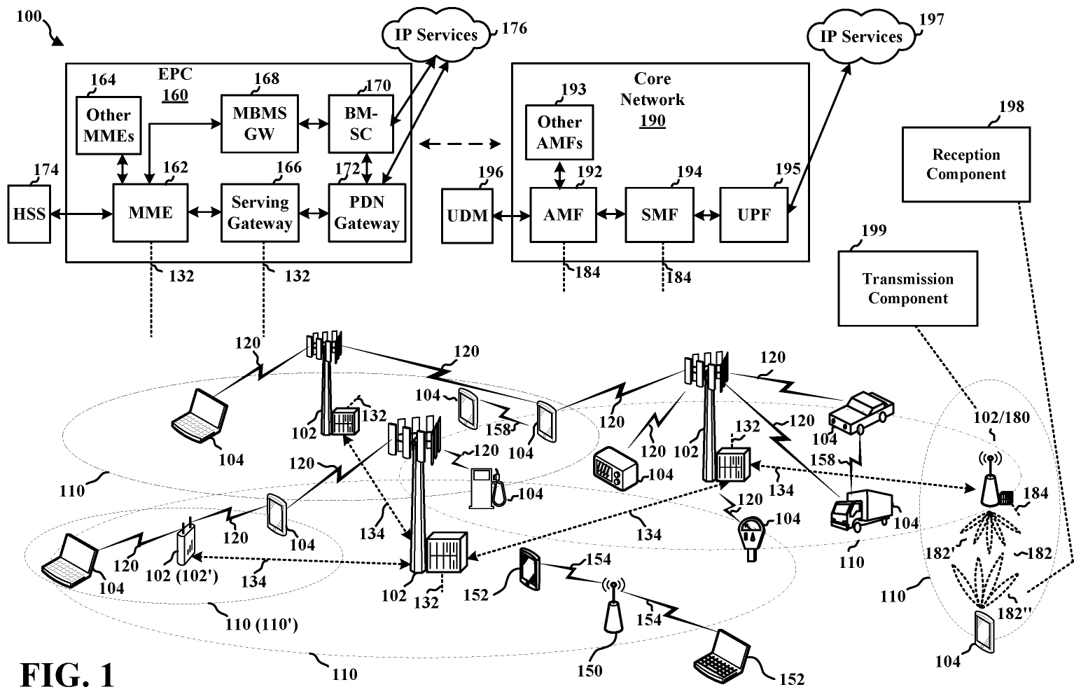

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a reception component 198 configured to receive, from a base station, an indication of at least one of an update to one or more power control (PC) parameters, an update to an uplink (UL) beam indication, or an update to the one or more PC parameters associated with the UL beam indication. Reception component 198 may also be configured to configure, based on the indication, a PC adjustment state for an active UL bandwidth part (BWP) of a component carrier (CC). Reception component 198 may also be configured to maintain the PC adjustment state for the active UL BWP of the CC; reset the PC adjustment state for the active UL BWP of the CC; or determine whether to reset the PC adjustment state for the active UL BWP of the CC. Reception component 198 may also be configured to reset the PC adjustment state for the active UL BWP of the CC when the one or more PC parameters associated with the UL common TCI state or the joint UL and DL common TCI state are updated. Reception component 198 may also be configured to transmit, to the base station, an uplink channel or an uplink signal based on the configured PC adjustment state for the active UL BWP of the CC.

Referring again to FIG. 1, in certain aspects, the base station 180 may include a transmission component 199 configured to transmit, to a user equipment (UE), an indication of at least one of an update to one or more power control (PC) parameters, an update to an uplink (UL) beam indication, or an update to the one or more PC parameters associated with the UL beam indication. Transmission component 199 may also be configured to receive, from the UE based on the indication, an uplink channel or an uplink signal based on a power control (PC) adjustment state for an active UL bandwidth part (BWP) of a component carrier (CC).

Although the following description may be focused on 5G NR, the concepts described herein may be applicable to other similar areas, such as LTE, LTE-A, CDMA, GSM, and other wireless technologies.

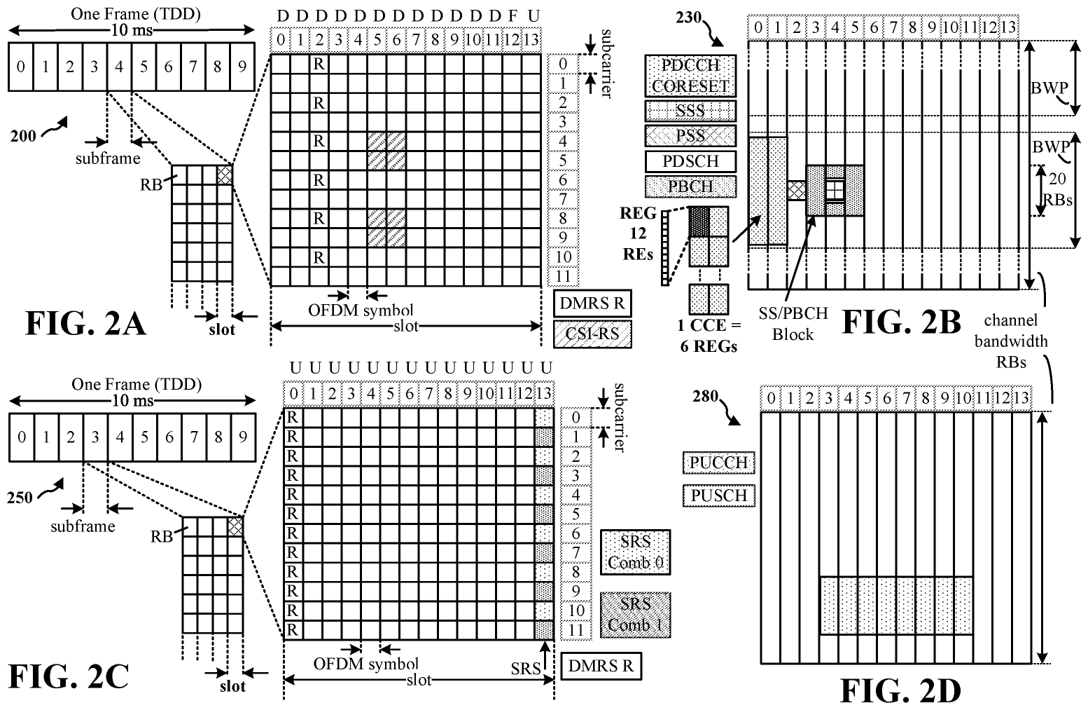

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ*15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

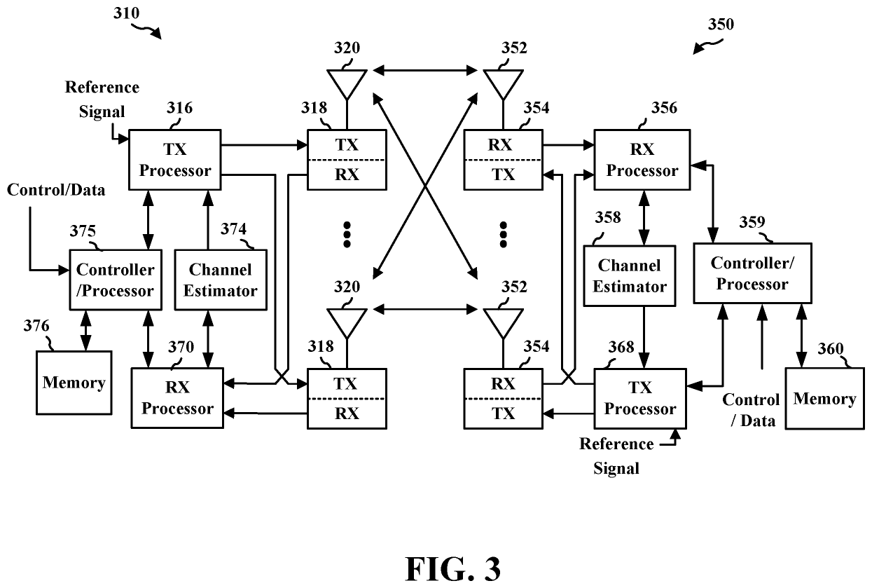

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

Some aspects of wireless communication may include transmission configuration indication (TCI) state indications. For instance, aspects of wireless communication may include different types of unified TCI indications. In one aspect, a joint downlink (DL)/uplink (UL) common TCI state may be utilized to indicate a common beam for at least one DL channel/reference signal (RS) and at least one UL channel/RS. In another aspect, a separate DL common TCI state may be utilized to indicate a common beam for more than one DL channel/RS. In yet another aspect, a separate UL common TCI state may be utilized to indicate a common beam for more than one UL channel/RS. In another aspect, a separate DL single channel/RS TCI state may be utilized to indicate a beam for a single DL channel/RS. In yet another aspect, a separate UL single channel/RS TCI state may be utilized to indicate a beam for a single UL channel/RS. In another aspect, UL spatial relation information (e.g., an SRS resource indicator (SRI)) may be utilized to indicate a beam for a single UL channel/RS.

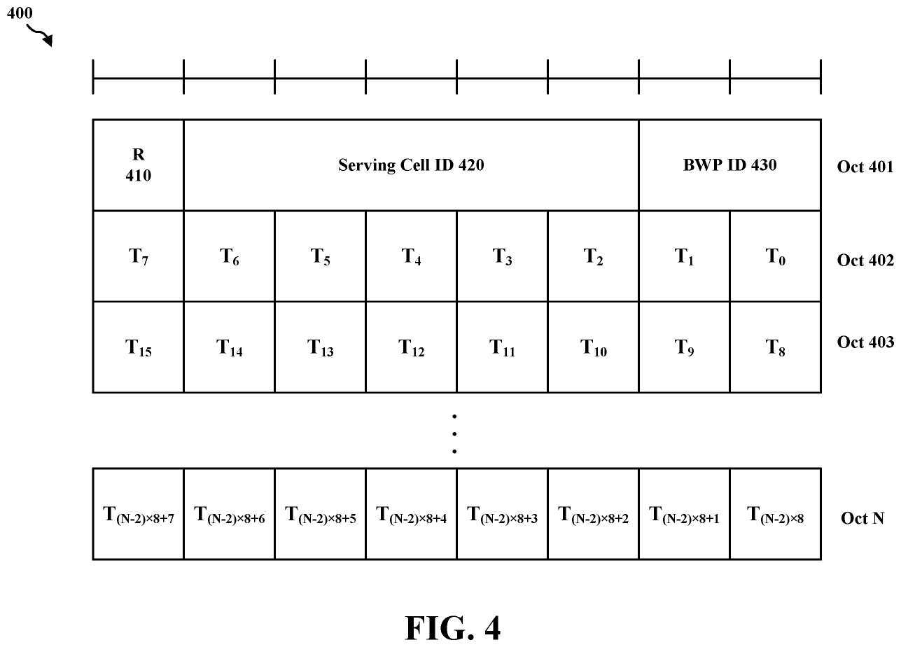

FIG. 4 illustrates a diagram 400 of one example of a MAC-CE utilized with TCI state indication. As shown in FIG. 4, the MAC-CE includes reserved bit (R) 410, serving cell identifier (ID) 420, and bandwidth part (BWP) ID 430, as well as a number of octets (Oct), e.g., Oct 401, Oct 402, Oct 403, and Oct N. The MAC-CE in diagram 400 may include a bitmap indicating which configured joint DL/UL TCI state(s) are activated, a serving cell ID, e.g., serving cell ID 420, and a BWP ID, e.g., BWP ID 430, for which the MAC-CE applies. As depicted in FIG. 4, the MAC-CE may include a variable sized bitmap including a reserved bit (R), a serving cell ID field, a BWP ID field, and a number of TCI state fields. For example, a first octet (Oct) of the bitmap of the MAC-CE, e.g., Oct 401, may include the reserved bit (R) 410, the serving cell ID 420, and the BWP ID 430.

In some aspects, the reserved bit (R) 410 may be set to zero (0). The serving cell ID 420 may indicate the identity of the serving cell for which the MAC-CE applies. For example, the length of the serving cell ID 420 may also be a number of bits, e.g., five (5) bits. The BWP ID 430 may indicate a DL BWP for which the MAC-CE applies as the codepoint. For example, the length of the BWP ID field may be a number of bits, e.g., two (2) bits.

As illustrated in FIG. 4, outside of the first octet, the remaining octets may be a bitmap of the joint DL/UL TCI states, where each bit corresponds to each joint DL/UL TCI state. As shown in FIG. 4, the bitmap may include a first TCI state, e.g., To, up through a last TCI state, e.g., T_{(N-2)×}8+7. If a bit is set to a certain value, e.g., one (1), then the corresponding joint DL/UL TCI state may be activated. If a bit is set to another value, e.g., zero (0), then the corresponding joint DL/UL TCI state may not be activated. The base station may configure up to a certain number of joint DL/UL TCI states, e.g., 128 joint DL/UL TCI states, and the bitmap may have a bit length of a certain number of bits, e.g., 128 bits. The MAC-CE in diagram 400 may select up to a certain amount of bits, e.g., eight (8) bits. As such, the bitmap may have up to this amount of bits, e.g., eight (8) bits, set to a certain value, e.g., one (1), in order to activate a corresponding joint DL/UL TCI state.

Additionally, aspects of wireless communication may include power control parameter indication schemes. Aspects of wireless communication may also down-select or combine from different alternatives for a pathloss (PL) reference signal (PL-RS), such as in association with a unified TCI framework. In some aspects, a PL-RS may be included in an UL TCI state or a joint TCI state. If not included in an UL TCI state or a joint TCI state, a PL-RS may be a periodic DL-RS used as a source RS for determining a spatial transmission (Tx) filter or the PL RS used for the UL RS in UL or joint TCI state. Additionally, a PL-RS may be associated with an UL TCI state or a joint TCI state. There may also be an association mechanism for the PL-RS. If not associated with an UL TCI state or a joint TCI state, a PL-RS may be the periodic DL-RS used as a source RS for determining a spatial Tx filter or the PL RS used for the UL RS in UL or a joint TCI state. Further, a UE may calculate a pathloss based on a periodic DL RS configured as the source RS for determining a spatial Tx filter in UL or a joint TCI state. If a PL RS is not included in or associated with the UL TCI state or the joint TCI state, the UE may or may not estimate the pathloss based on the PL-RS of an UL RS provided in an UL TCI state or a joint TCI state as a source RS for determining the spatial Tx filter.

Some aspects of wireless communication may also include an existing power control (PC) state reset rule. For instance, the PC state may be reset if a PC parameter is updated by the network. The PC state may also be reset when a target signal-to-noise ratio (SNR) value (i.e., P0) or a PL compensation factor (i.e., alpha or a) is reconfigured. The PC state may be any accumulation of the PUSCH power control adjustment state, the PUCCH power control adjustment state, or the SRS power control adjustment state.

In some aspects, if a UE transmits a PUSCH on an active UL BWP b of carrier f of serving cell c using a parameter set configuration with index j and PUSCH power control adjustment state with index l, the UE may determine the PUSCH transmission power P_{PUSCH,b,f,c}(i,j,q_{d},l) in PUSCH transmission occasion i as:

$${P}_{PUSCH , b , f , c} ( i , j , {q}_{d} , l ) = min \{ \begin{matrix}{P}_{CMAX , f , c} ( i ) , \\ {P}_{O\_PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \}$$

where f_{b,f,c}(i,l) is the PUSCH power control adjustment state for active UL BWP b of carrier f of serving cell c in PUSCH transmission occasion i, which may be a sum of TPC command values in a duration associated with the PUSCH transmission occasion i. A UE may reset accumulation of a PUSCH power control adjustment state l for active UL BWP b of carrier f of serving cell c to f_{b,f,c}(k,l)=0, k=0, 1, . . . j. If a UE transmits a PUCCH on active UL BWP b of carrier f in the primary cell c using PUCCH power control adjustment state with index l, the UE may determine the PUCCH transmission power P_{PUCCH,b,f,c}(i,qₛ,q_{d},l) in PUCCH transmission occasion i as:

$${P}_{PUCCH , b , f , c} ( i , {q}_{u} , {q}_{d} , l ) = min \{ \begin{matrix}{P}_{CMAX , f , c} ( i ) , \\ {P}_{O\_PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F\_PUCCH} ( F ) + {Δ}_{TF , b , f , c} ( i ) + {g}_{b , f , c} ( i , l )\end{matrix} \}$$

where g_{b,f,c}(i,l) is the PUCCH power control adjustment state for active UL BWP b of carrier f of primary cell c and PUCCH transmission occasion i which may be a sum of TPC command values in a duration associated with the PUCCH transmission occasion i. A UE may reset accumulation of the PUCCH power control adjustment state l for active UL BWP b of carrier f of primary cell c as g_{b,f,c}(k,l)=0, k=0, 1, . . . , j.

In some aspects, a UE may reset the accumulation of a PUSCH or PUCCH power control adjustment state with index l for an active UL BWP b of a carrier f of a serving cell c. This may be based on if a configuration for a corresponding value (i.e., P0 or α) is provided by higher layers. This may also be based on whether a PUSCH or PUCCH power control adjustment state associated with index l is determined from a certain value, e.g., j. For example, if j>1 and the UE is provided higher SRI-PUSCH-PowerControl, l may be the sri-PUSCH-ClosedLooplndex value(s) configured in any SRI-PUSCH-PowerControl with the sri-P0-PUSCH-AlphaSetld value corresponding to j. If j>1 and the UE is not provided SRI-PUSCH-PowerControl or j=0,l may be equal to 0. If j=1,l may be provided by the value of powerControlLoopToUse.

In some instances, a UE may transmit a PUSCH, a PUCCH, or an SRS on an active UL BWP b of a carrier f of a serving cell c using a parameter set configuration with an index j and a PUSCH, a PUCCH, or an SRS power control adjustment state with index l, the UE may determine the PUSCH, PUCCH, or SRS transmission power in a PUSCH, PUCCH, or SRS transmission occasion. There may also be a PUSCH, PUCCH, or SRS power control adjustment state with index l for an active UL BWP b of a carrier f of a serving cell c and a PUSCH, PUCCH, or SRS transmission occasion i. Further, the UE may receive a sum of transmission power control (TPC) command values between a number of symbols before a PUSCH, PUCCH, or SRS transmission occasion.

In some aspects of wireless communication, PC parameters (any of P0, alpha, closed loop index, PL-RS) may be associated with an UL or joint TCI state. If associated with an UL or joint TCI state, PC parameters may change whenever the UL or joint TCI state is updated for applicable UL channels/RSs. Based on some configurations, it may be implied that a corresponding PC state may be reset. However, the PC state resetting may not be desired when PC parameters are changed or an associated TCI state is changed. For instance, this may lead to a Tx power drop due to an inaccurate PL estimation due to insufficient samples. Further, the Tx power drop may be too low to maintain a desired Tx power level, and Tx power recovery may need a long time.

Based on the above, it may be beneficial to reset a PC state and maintain a Tx power level. For instance, it may be beneficial to reset a PC state when PC parameters are changed or an associated TCI state is changed, and still maintain a desired Tx power level. In some instances, it may also be beneficial to reset a PC state and maintain a Tx power level without any Tx power recovery time when PC parameters are changed or an associated TCI state is changed. It may also be beneficial to not reset a PC state and maintain a Tx power level when PC parameters are changed or an associated TCI state is changed.

Aspects of the present disclosure may reset a PC state and maintain a Tx power level. For instance, aspects of the present disclosure may reset a PC state when PC parameters are changed or an associated TCI state is changed, and still maintain a desired Tx power level. Further, aspects of the present disclosure may reset a PC state and maintain a Tx power level without any Tx power recovery time. Aspects of the present disclosure may also not reset a PC state and maintain a Tx power level.

Aspects of the present disclosure may include a PC state reset behavior when some PC parameter(s) are updated or an associated UL beam indication is updated. For instance, a PC state may not be reset when some PC parameters are updated or an associated UL beam indication is updated. Also, a PC state may be reset when some PC parameters are updated or an associated UL beam indication is updated. Further, the PC state reset may be up to a UE implementation. The above PC parameters may include any subset of P0 (i.e., a target signal-to-noise ratio (SNR) value), alpha (i.e., a pathloss (PL) compensation factor), a closed loop index, or a PL RS. In some instances, the implementation may be clarified for a change to P0 and alpha, and whether the PC state resetting or not resetting may be up to a UE implementation for the remaining parameter changes. The applicable channels or RSs may include PC for a physical uplink shared channel (PUSCH), a physical uplink control channel (PUCCH), a sounding reference signal (SRS), or a physical random access channel (PRACH). The above UL beam indication may at least include spatial relation information, as well as a separate UL common TCI state and a joint DL/UL common TCI state.

In some aspects of the present disclosure, if the associated PC parameters are updated for an UL TCI state or a joint TCI state, the specification of the TCI state may correspond to a number of options. For instance, the TCI state may be selected for an UL transmission. This selection may be indicated via downlink control information (DCI), a medium access control (MAC) control element (MAC-CE), or radio resource control (RRC) signaling. Also, the UL transmission may include any of a PUSCH, a PUCCH, an SRS, or a PRACH. The TCI state may also be activated for a potential UL transmission. For example, the activation may be via a MAC-CE, regardless of whether each activated TCI state is selected via DCI for an UL transmission or not. Additionally, the TCI state may be configured for a potential UL transmission. For example, the TCI state may be configured for an SRS or PUCCH resource, e.g., an SP/AP SRS/PUCCH resource, that is potentially activated or scheduled for transmission.

Additionally, the update of the associated PC parameters may include a number of different options. In some instances, the PC parameters may be configured in the associated TCI state information element (IE). The PC parameters may also be configured outside of the associated TCI state IE, and the PC parameters may be further linked to the associated TCI state. This linkage may be configured via RRC signaling. This linkage may be dynamically updated via DCI or a MAC-CE. Further, the TCI independent PC parameters may be configured outside of any TCI state IE. The PC parameters may also be applied to all TCI states without any associated PC parameters. In some instances, the update of associated PC parameters may refer to the updates mentioned above. For example, the update may be via a reconfiguration in the TCI, a reconfiguration of the linkage, or a reconfiguration of the TCI independent PC parameters. The update may also refer to the update via switching across different alternatives, e.g., switching from one alternative to another by removing the associated PC parameters configured in the TCI.

In some aspects of the present disclosure, a UE may reset the PUSCH PC adjustment state when P0 (i.e., a target signal-to-noise ratio (SNR) value) or alpha (i.e., a pathloss (PL) compensation factor) is reconfigured. The PC parameters may be associated with an UL TCI state or a joint TCI state. A UE may also reset the PC state if the associated PC parameters are updated for an UL TCI state or joint TCI state used for UL transmission. Also, a UE may reset the PC adjustment state for the active UL BWP of the CC when one or more PC parameters associated with an UL common TCI state or a joint UL and DL common TCI state are updated.

Aspects of the present disclosure may also include a PC state reset when some PC parameters, unified TCI states, or the association between PC parameters and unified TCI states are reconfigured via RRC signaling. For instance, a PC state may not be reset when some PC parameters are reconfigured, unified TCI states are reconfigured, and/or the association between PC parameters and unified TCI states is reconfigured. A PC state may also be reset when some PC parameters are reconfigured, unified TCI states are reconfigured, and/or the association between PC parameters and unified TCI states is reconfigured. Further, the PC state reset may be determined by a UE implementation. The above PC parameters may include any subset of P0 (i.e., a target signal-to-noise ratio (SNR) value), alpha (i.e., a pathloss (PL) compensation factor), a closed loop index, or a PL RS. In some instances, the above PC state reset may apply to P0 and alpha reconfiguration, and resetting the PC state or not may be based on a UE implementation for the remaining parameter changes. The applicable channels or RSs may include PC for a physical uplink shared channel (PUSCH), a physical uplink control channel (PUCCH), a sounding reference signal (SRS), or a physical random access channel (PRACH). Additionally, the above UL beam indication may include at least spatial relation information, as well as a separate UL common TCI state and a joint DL/UL common TCI state.

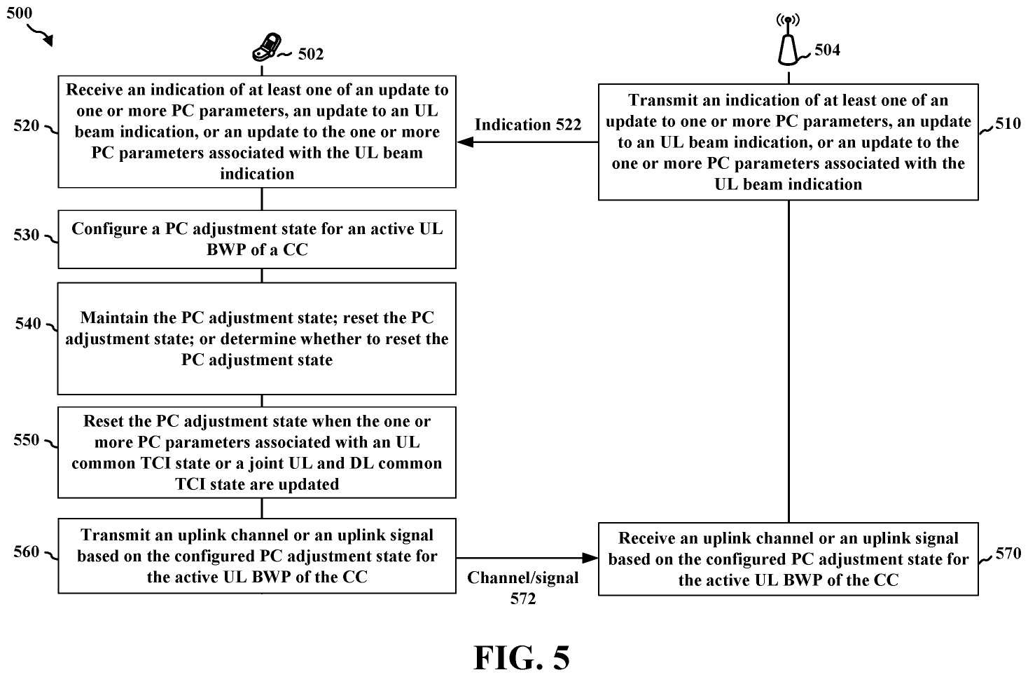

FIG. 5 is a diagram 500 illustrating example communication between a UE 502 and a base station 504.

At 510, base station 504 may transmit, to a UE, an indication of at least one of an update to one or more power control (PC) parameters, an update to an uplink (UL) beam indication, or an update to the one or more PC parameters associated with the UL beam indication, e.g., indication 522.

At 520, the UE 502 may receive, from a base station, an indication of at least one of an update to one or more power control (PC) parameters, an update to an uplink (UL) beam indication, or an update to the one or more PC parameters associated with the UL beam indication, e.g., indication 522.

At 530, the UE 502 may configure, based on the indication, a PC adjustment state for an active UL bandwidth part (BWP) of a component carrier (CC).

At 540, the UE 502 may maintain the PC adjustment state for the active UL BWP of the CC; reset the PC adjustment state for the active UL BWP of the CC; or determine whether to reset the PC adjustment state for the active UL BWP of the CC. For instance, configuring the PC adjustment state for the active UL BWP of the CC may include maintaining the PC adjustment state for the active UL BWP of the CC; resetting the PC adjustment state for the active UL BWP of the CC; or determining whether to reset the PC adjustment state for the active UL BWP of the CC.

In some aspects, the indication may be based on a pre-configuration via high layer signaling. Further, configuring the PC adjustment state for the active UL BWP of the CC may include maintaining the PC adjustment state for the active UL BWP of the CC. The indication may be received via downlink control information (DCI) or a medium access control (MAC) control element (MAC-CE). Additionally, the indication may be based on an updated configuration via high layer signaling. Also, configuring the PC adjustment state for the active UL BWP of the CC may include resetting the PC adjustment state for the active UL BWP of the CC. The indication may be received via radio resource control (RRC) signaling.

In some instances, the UL beam indication may include at least one of spatial relation information, an UL common transmission configuration indication (TCI) state, or a joint UL and downlink (DL) common TCI state. The indication may correspond to an update to the one or more PC parameters associated with the UL common TCI state or the joint UL and DL common TCI state. The UL common TCI state or the joint UL and DL common TCI state may be: (1) selected for an UL transmission, (2) activated for a potential UL transmission, or (3) configured for the potential UL transmission. The one or more PC parameters may be: (1) configured in an associated TCI state information element (IE), (2) configured outside of the associated TCI state IE, or (3) configured outside of all TCI state IEs and applied to all TCI states.

Additionally, the one or more PC parameters may include at least one of: a target signal-to-noise ratio (SNR) value (P0), a pathloss (PL) compensation factor (alpha), a closed loop index, or a PL reference signal (RS). The PC adjustment state may correspond to a physical uplink shared channel (PUSCH) PC adjustment state, a physical uplink control channel (PUCCH) PC adjustment state, or a sounding reference signal (SRS) PC adjustment state. The uplink channel or the uplink signal may be a physical uplink shared channel (PUSCH), a physical uplink control channel (PUCCH), a sounding reference signal (SRS), or a physical random access channel (PRACH).

At 550, the UE 502 may reset the PC adjustment state for the active UL BWP of the CC when the one or more PC parameters associated with the UL common TCI state or the joint UL and DL common TCI state are updated.

At 560, the UE 502 may transmit, to the base station, an uplink channel or an uplink signal based on the configured PC adjustment state for the active UL BWP of the CC, e.g., channel/signal 572.

At 570, base station 504 may receive, from the UE based on the indication, an uplink channel or an uplink signal based on a power control (PC) adjustment state for an active UL bandwidth part (BWP) of a component carrier (CC), e.g., channel/signal 572.

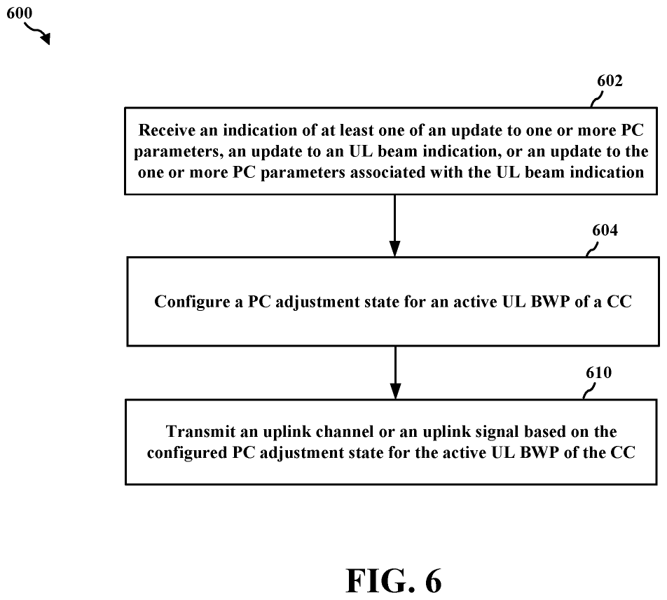

FIG. 6 is a flowchart 600 of a method of wireless communication. The method may be performed by a UE or a component of a UE (e.g., the UE 104, 350, 502; the apparatus 902). The methods described herein may provide a number of benefits, such as improving communication signaling, resource utilization, and/or power savings.

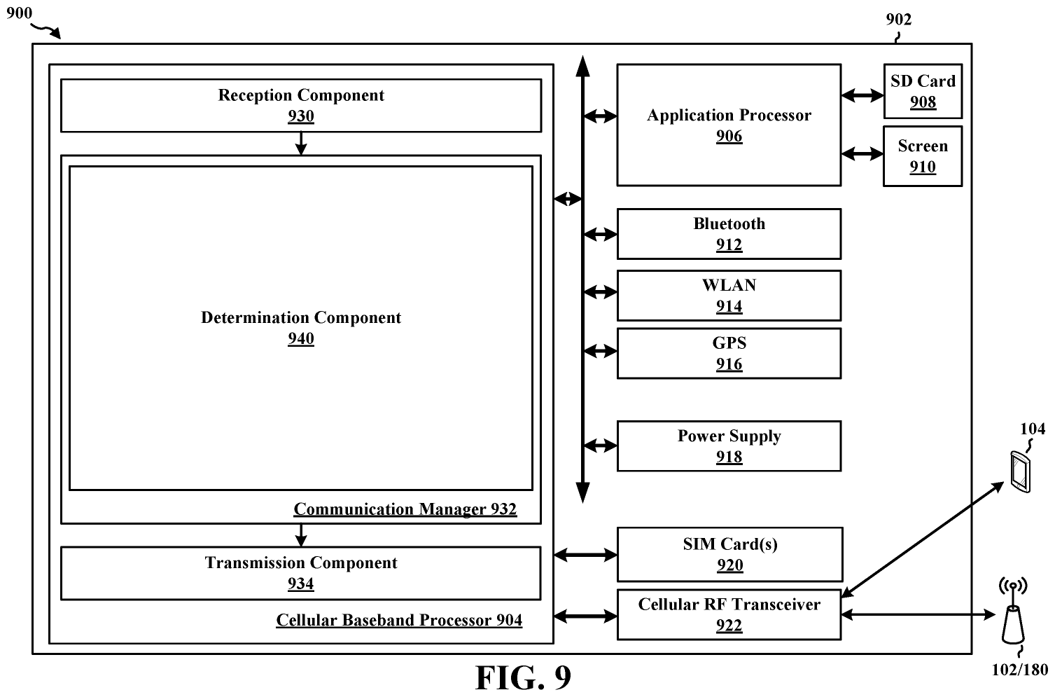

At 602, the UE may receive, from a base station, an indication of at least one of an update to one or more power control (PC) parameters, an update to an uplink (UL) beam indication, or an update to the one or more PC parameters associated with the UL beam indication, as described in connection with the examples in FIGS. 4-5. For example, UE 502 may receive, from a base station, an indication of at least one of an update to one or more power control (PC) parameters, an update to an uplink (UL) beam indication, or an update to the one or more PC parameters associated with the UL beam indication, as described in connection with 520 in FIG. 5. Further, 602 may be performed by determination component 940 in FIG. 9.

At 604, the UE may configure, based on the indication, a PC adjustment state for an active UL bandwidth part (BWP) of a component carrier (CC), as described in connection with the examples in FIGS. 4-5. For example, UE 502 may configure, based on the indication, a PC adjustment state for an active UL bandwidth part (BWP) of a component carrier (CC), as described in connection with 530 in FIG. 5. Further, 604 may be performed by determination component 940 in FIG. 9.

In some aspects, the indication may be based on a pre-configuration via high layer signaling. Further, configuring the PC adjustment state for the active UL BWP of the CC may include maintaining the PC adjustment state for the active UL BWP of the CC. The indication may be received via downlink control information (DCI) or a medium access control (MAC) control element (MAC-CE). Additionally, the indication may be based on an updated configuration via high layer signaling. Also, configuring the PC adjustment state for the active UL BWP of the CC may include resetting the PC adjustment state for the active UL BWP of the CC. The indication may be received via radio resource control (RRC) signaling.

In some instances, the UL beam indication may include at least one of spatial relation information, an UL common transmission configuration indication (TCI) state, or a joint UL and downlink (DL) common TCI state. The indication may correspond to an update to the one or more PC parameters associated with the UL common TCI state or the joint UL and DL common TCI state. The UL common TCI state or the joint UL and DL common TCI state may be: (1) selected for an UL transmission, (2) activated for a potential UL transmission, or (3) configured for the potential UL transmission. The one or more PC parameters may be: (1) configured in an associated TCI state information element (IE), (2) configured outside of the associated TCI state IE, or (3) configured outside of all TCI state IEs and applied to all TCI states.

Additionally, the one or more PC parameters may include at least one of: a target signal-to-noise ratio (SNR) value (P0), a pathloss (PL) compensation factor (alpha), a closed loop index, or a PL reference signal (RS). The PC adjustment state may correspond to a physical uplink shared channel (PUSCH) PC adjustment state, a physical uplink control channel (PUCCH) PC adjustment state, or a sounding reference signal (SRS) PC adjustment state. The uplink channel or the uplink signal may be a physical uplink shared channel (PUSCH), a physical uplink control channel (PUCCH), a sounding reference signal (SRS), or a physical random access channel (PRACH).

At 610, the UE may transmit, to the base station, an uplink channel or an uplink signal based on the configured PC adjustment state for the active UL BWP of the CC, as described in connection with the examples in FIGS. 4-5. For example, UE 502 may transmit, to the base station, an uplink channel or an uplink signal based on the configured PC adjustment state for the active UL BWP of the CC, as described in connection with 560 in FIG. 5. Further, 610 may be performed by determination component 940 in FIG. 9.

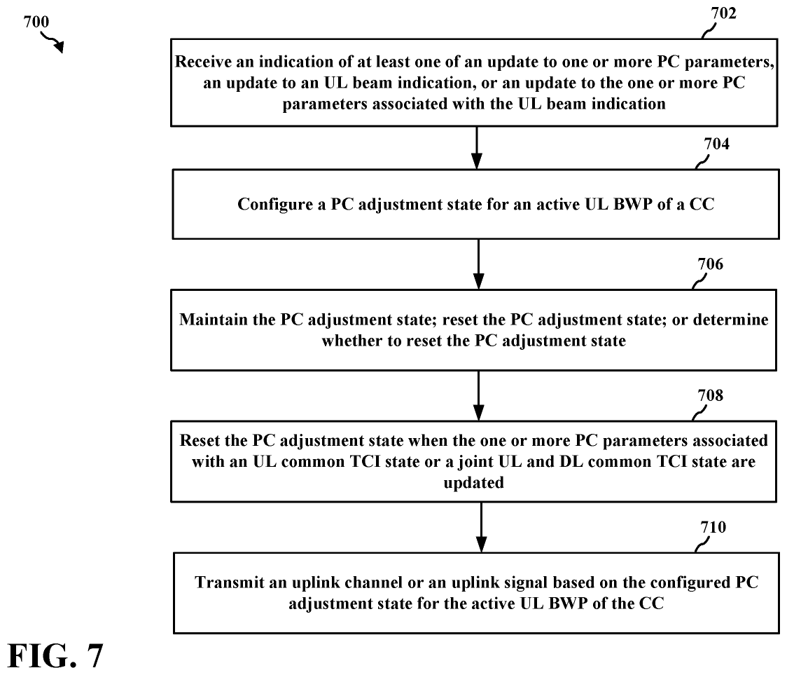

FIG. 7 is a flowchart 700 of a method of wireless communication. The method may be performed by a UE or a component of a UE (e.g., the UE 104, 350, 502; the apparatus 902). The methods described herein may provide a number of benefits, such as improving communication signaling, resource utilization, and/or power savings.

At 702, the UE may receive, from a base station, an indication of at least one of an update to one or more power control (PC) parameters, an update to an uplink (UL) beam indication, or an update to the one or more PC parameters associated with the UL beam indication, as described in connection with the examples in FIGS. 4-5. For example, UE 502 may receive, from a base station, an indication of at least one of an update to one or more power control (PC) parameters, an update to an uplink (UL) beam indication, or an update to the one or more PC parameters associated with the UL beam indication, as described in connection with 520 in FIG. 5. Further, 702 may be performed by determination component 940 in FIG. 9.

At 704, the UE may configure, based on the indication, a PC adjustment state for an active UL bandwidth part (BWP) of a component carrier (CC), as described in connection with the examples in FIGS. 4-5. For example, UE 502 may configure, based on the indication, a PC adjustment state for an active UL bandwidth part (BWP) of a component carrier (CC), as described in connection with 530 in FIG. 5. Further, 704 may be performed by determination component 940 in FIG. 9.

At 706, the UE may maintain the PC adjustment state for the active UL BWP of the CC; reset the PC adjustment state for the active UL BWP of the CC; or determine whether to reset the PC adjustment state for the active UL BWP of the CC, as described in connection with the examples in FIGS. 4-5. For example, UE 502 may maintain the PC adjustment state for the active UL BWP of the CC; reset the PC adjustment state for the active UL BWP of the CC; or determine whether to reset the PC adjustment state for the active UL BWP of the CC, as described in connection with 540 in FIG. 5. Further, 706 may be performed by determination component 940 in FIG. 9. For instance, configuring the PC adjustment state for the active UL BWP of the CC may include maintaining the PC adjustment state for the active UL BWP of the CC; resetting the PC adjustment state for the active UL BWP of the CC; or determining whether to reset the PC adjustment state for the active UL BWP of the CC.

In some aspects, the indication may be based on a pre-configuration via high layer signaling. Further, configuring the PC adjustment state for the active UL BWP of the CC may include maintaining the PC adjustment state for the active UL BWP of the CC. The indication may be received via downlink control information (DCI) or a medium access control (MAC) control element (MAC-CE). Additionally, the indication may be based on an updated configuration via high layer signaling. Also, configuring the PC adjustment state for the active UL BWP of the CC may include resetting the PC adjustment state for the active UL BWP of the CC. The indication may be received via radio resource control (RRC) signaling.

In some instances, the UL beam indication may include at least one of spatial relation information, an UL common transmission configuration indication (TCI) state, or a joint UL and downlink (DL) common TCI state. The indication may correspond to an update to the one or more PC parameters associated with the UL common TCI state or the joint UL and DL common TCI state. The UL common TCI state or the joint UL and DL common TCI state may be: (1) selected for an UL transmission, (2) activated for a potential UL transmission, or (3) configured for the potential UL transmission. The one or more PC parameters may be: (1) configured in an associated TCI state information element (IE), (2) configured outside of the associated TCI state IE, or (3) configured outside of all TCI state IEs and applied to all TCI states.

Additionally, the one or more PC parameters may include at least one of: a target signal-to-noise ratio (SNR) value (P0), a pathloss (PL) compensation factor (alpha), a closed loop index, or a PL reference signal (RS). The PC adjustment state may correspond to a physical uplink shared channel (PUSCH) PC adjustment state, a physical uplink control channel (PUCCH) PC adjustment state, or a sounding reference signal (SRS) PC adjustment state. The uplink channel or the uplink signal may be a physical uplink shared channel (PUSCH), a physical uplink control channel (PUCCH), a sounding reference signal (SRS), or a physical random access channel (PRACH).

At 708, the UE may reset the PC adjustment state for the active UL BWP of the CC when the one or more PC parameters associated with the UL common TCI state or the joint UL and DL common TCI state are updated, as described in connection with the examples in FIGS. 4-5. For example, UE 502 may reset the PC adjustment state for the active UL BWP of the CC when the one or more PC parameters associated with the UL common TCI state or the joint UL and DL common TCI state are updated, as described in connection with 550 in FIG. 5. Further, 708 may be performed by determination component 940 in FIG. 9.

At 710, the UE may transmit, to the base station, an uplink channel or an uplink signal based on the configured PC adjustment state for the active UL BWP of the CC, as described in connection with the examples in FIGS. 4-5. For example, UE 502 may transmit, to the base station, an uplink channel or an uplink signal based on the configured PC adjustment state for the active UL BWP of the CC, as described in connection with 560 in FIG. 5. Further, 710 may be performed by determination component 940 in FIG. 9.

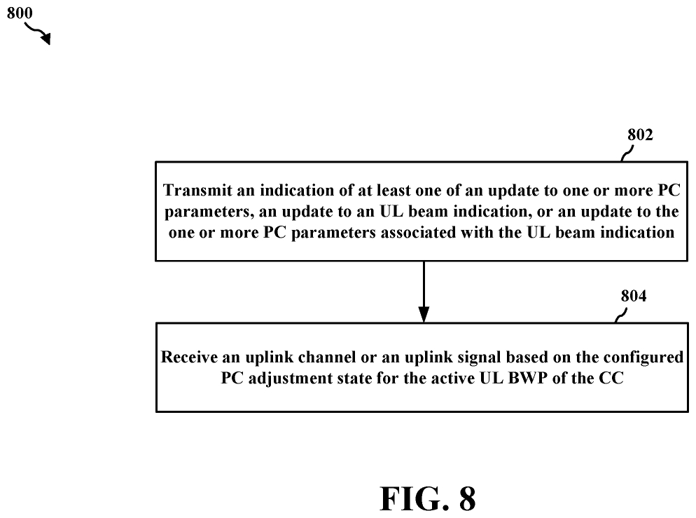

FIG. 8 is a flowchart 800 of a method of wireless communication. The method may be performed by a base station or a component of a base station (e.g., the base station 102, 180, 310, 504; the apparatus 1002). The methods described herein may provide a number of benefits, such as improving communication signaling, resource utilization, and/or power savings.

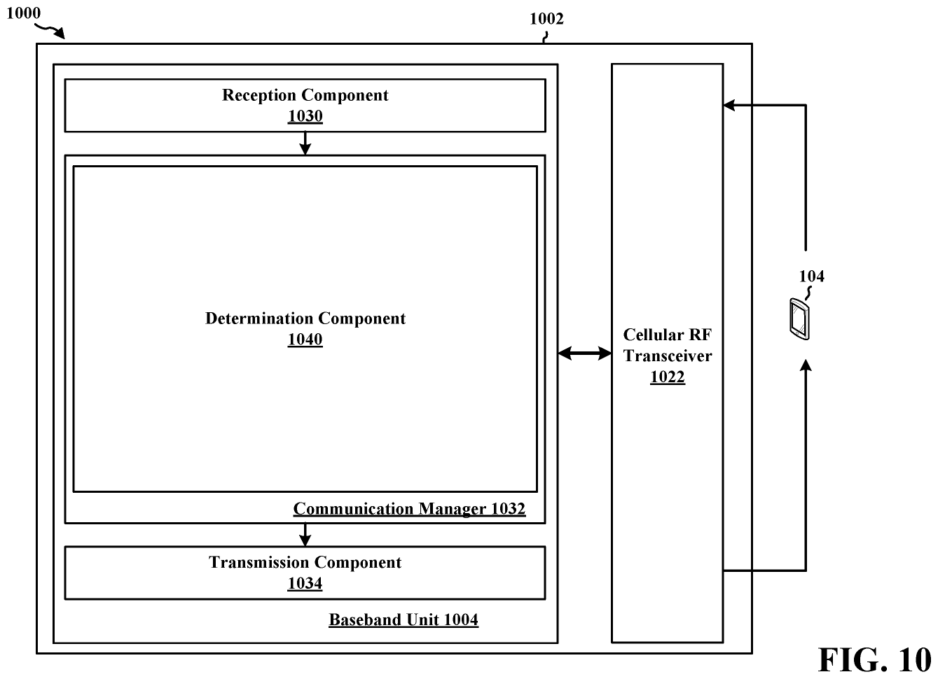

At 802, the base station may transmit, to a user equipment (UE), an indication of at least one of an update to one or more power control (PC) parameters, an update to an uplink (UL) beam indication, or an update to the one or more PC parameters associated with the UL beam indication, as described in connection with the examples in FIGS. 4-5. For example, base station 504 may transmit, to a UE, an indication of at least one of an update to one or more power control (PC) parameters, an update to an uplink (UL) beam indication, or an update to the one or more PC parameters associated with the UL beam indication, as described in connection with 510 in FIG. 5. Further, 802 may be performed by determination component 1040 in FIG. 10.

In some aspects, the PC adjustment state for the active UL BWP of the CC may be maintained or reset based on the indication. The indication may be based on a pre-configuration via high layer signaling. The PC adjustment state for the active UL BWP of the CC may be maintained, and the indication may be transmitted via downlink control information (DCI) or a medium access control (MAC) control element (MAC-CE). Also, the indication may be based on an updated configuration via high layer signaling. The PC adjustment state for the active UL BWP of the CC may be reset, and the indication may be transmitted via radio resource control (RRC) signaling.

In some instances, the UL beam indication may include at least one of spatial relation information, an UL common transmission configuration indication (TCI) state, or a joint UL and downlink (DL) common TCI state. The indication may correspond to an update to the one or more PC parameters associated with the UL common TCI state or the joint UL and DL common TCI state. The UL common TCI state or the joint UL and DL common TCI state may be: (1) selected for an UL transmission, (2) activated for a potential UL transmission, or (3) configured for the potential UL transmission. The one or more PC parameters may be: (1) configured in an associated TCI state information element (IE), (2) configured outside of the associated TCI state IE, or (3) configured outside of all TCI state IEs and applied to all TCI states. The PC adjustment state for the active UL BWP of the CC may be reset when the one or more PC parameters associated with the UL common TCI state or the joint UL and DL common TCI state are updated.

Additionally, the one or more PC parameters may include at least one of: a target signal-to-noise ratio (SNR) value (P0), a pathloss (PL) compensation factor (alpha), a closed loop index, or a PL reference signal (RS). The PC adjustment state may correspond to a physical uplink shared channel (PUSCH) PC adjustment state, a physical uplink control channel (PUCCH) PC adjustment state, or a sounding reference signal (SRS) PC adjustment state. The uplink channel or the uplink signal may be a physical uplink shared channel (PUSCH), a physical uplink control channel (PUCCH), a sounding reference signal (SRS), or a physical random access channel (PRACH).

At 804, the base station may receive, from the UE based on the indication, an uplink channel or an uplink signal based on a power control (PC) adjustment state for an active UL bandwidth part (BWP) of a component carrier (CC), as described in connection with the examples in FIGS. 4-5. For example, base station 504 may receive, from the UE based on the indication, an uplink channel or an uplink signal based on a power control (PC) adjustment state for an active UL bandwidth part (BWP) of a component carrier (CC), as described in connection with 570 in FIG. 5. Further, 804 may be performed by determination component 1040 in FIG. 10.

FIG. 9 is a diagram 900 illustrating an example of a hardware implementation for an apparatus 902. The apparatus 902 may be a UE, a component of a UE, or may implement UE functionality. In some aspects, the apparatus 902 may include a cellular baseband processor 904 (also referred to as a modem) coupled to a cellular RF transceiver 922. In some aspects, the apparatus 902 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The cellular baseband processor 904 communicates through the cellular RF transceiver 922 with the UE 104 and/or BS 102/180. The cellular baseband processor 904 may include a computer-readable medium/memory. The computer-readable medium/memory may be non-transitory. The cellular baseband processor 904 is responsible for general processing, including the execution of software stored on the computer-readable medium/memory. The software, when executed by the cellular baseband processor 904, causes the cellular baseband processor 904 to perform the various functions described supra. The computer-readable medium/memory may also be used for storing data that is manipulated by the cellular baseband processor 904 when executing software. The cellular baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the cellular baseband processor 904. The cellular baseband processor 904 may be a component of the UE 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the additional modules of the apparatus 902.

The communication manager 932 includes a determination component 940 that is configured to receive, from a base station, an indication of at least one of an update to one or more power control (PC) parameters, an update to an uplink (UL) beam indication, or an update to the one or more PC parameters associated with the UL beam indication, e.g., as described in connection with step 702 above. Determination component 940 may also be configured to configure, based on the indication, a PC adjustment state for an active UL bandwidth part (BWP) of a component carrier (CC), e.g., as described in connection with step 704 above. Determination component 940 may also be configured to maintain the PC adjustment state for the active UL BWP of the CC; reset the PC adjustment state for the active UL BWP of the CC; or determine whether to reset the PC adjustment state for the active UL BWP of the CC, e.g., as described in connection with step 706 above. Determination component 940 may also be configured to reset the PC adjustment state for the active UL BWP of the CC when the one or more PC parameters associated with the UL common TCI state or the joint UL and DL common TCI state are updated, e.g., as described in connection with step 708 above. Determination component 940 may also be configured to transmit, to the base station, an uplink channel or an uplink signal based on the configured PC adjustment state for the active UL BWP of the CC, e.g., as described in connection with step 710 above.

The apparatus may include additional components that perform each of the blocks of the algorithm in the flowcharts of FIGS. 5, 6, and 7. As such, each block in the flowcharts of FIGS. 5, 6, and 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 902 may include a variety of components configured for various functions. In one configuration, the apparatus 902, and in particular the cellular baseband processor 904, includes means for receiving, from a base station, an indication of at least one of an update to one or more power control (PC) parameters, an update to an uplink (UL) beam indication, or an update to the one or more PC parameters associated with the UL beam indication; means for configuring, based on the indication, a PC adjustment state for an active UL bandwidth part (BWP) of a component carrier (CC); means for maintaining the PC adjustment state for the active UL BWP of the CC; means for resetting the PC adjustment state for the active UL BWP of the CC; means for determining whether to reset the PC adjustment state for the active UL BWP of the CC; means for resetting the PC adjustment state for the active UL BWP of the CC when the one or more PC parameters associated with the UL common TCI state or the joint UL and DL common TCI state are updated; and means for transmitting, to the base station, an uplink channel or an uplink signal based on the configured PC adjustment state for the active UL BWP of the CC. The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

FIG. 10 is a diagram 1000 illustrating an example of a hardware implementation for an apparatus 1002. The apparatus 1002 may be a base station, a component of a base station, or may implement base station functionality. In some aspects, the apparatus 1002 may include a baseband unit 1004. The baseband unit 1004 may communicate through a cellular RF transceiver 1022 with the UE 104. The baseband unit 1004 may include a computer-readable medium/memory. The baseband unit 1004 is responsible for general processing, including the execution of software stored on the computer-readable medium/memory. The software, when executed by the baseband unit 1004, causes the baseband unit 1004 to perform the various functions described supra. The computer-readable medium/memory may also be used for storing data that is manipulated by the baseband unit 1004 when executing software. The baseband unit 1004 further includes a reception component 1030, a communication manager 1032, and a transmission component 1034. The communication manager 1032 includes the one or more illustrated components. The components within the communication manager 1032 may be stored in the computer-readable medium/memory and/or configured as hardware within the baseband unit 1004. The baseband unit 1004 may be a component of the base station 310 and may include the memory 376 and/or at least one of the TX processor 316, the RX processor 370, and the controller/processor 375.

The communication manager 1032 includes a determination component 1040 that is configured to transmit, to a user equipment (UE), an indication of at least one of an update to one or more power control (PC) parameters, an update to an uplink (UL) beam indication, or an update to the one or more PC parameters associated with the UL beam indication, e.g., as described in connection with step 802 above. Determination component 1040 may also be configured to receive, from the UE based on the indication, an uplink channel or an uplink signal based on a power control (PC) adjustment state for an active UL bandwidth part (BWP) of a component carrier (CC), e.g., as described in connection with step 804 above.

The apparatus may include additional components that perform each of the blocks of the algorithm in the flowcharts of FIGS. 5 and 8. As such, each block in the flowcharts of FIGS. 5 and 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1002 may include a variety of components configured for various functions. In one configuration, the apparatus 1002, and in particular the baseband unit 1004, includes means for transmitting, to a user equipment (UE), an indication of at least one of an update to one or more power control (PC) parameters, an update to an uplink (UL) beam indication, or an update to the one or more PC parameters associated with the UL beam indication; and means for receiving, from the UE based on the indication, an uplink channel or an uplink signal based on a power control (PC) adjustment state for an active UL bandwidth part (BWP) of a component carrier (CC). The means may be one or more of the components of the apparatus 1002 configured to perform the functions recited by the means. As described supra, the apparatus 1002 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a UE including at least one processor coupled to a memory and configured to: receive, from a base station, an indication of at least one of an update to one or more power control (PC) parameters, an update to an uplink (UL) beam indication, or an update to the one or more PC parameters associated with the UL beam indication; configure, based on the indication, a PC adjustment state for an active UL bandwidth part (BWP) of a component carrier (CC); and transmit, to the base station, an uplink channel or an uplink signal based on the configured PC adjustment state for the active UL BWP of the CC.

Aspect 2 is the apparatus of aspect 1, where to configure the PC adjustment state for the active UL BWP of the CC, the at least one processor is configured to: maintain the PC adjustment state for the active UL BWP of the CC; reset the PC adjustment state for the active UL BWP of the CC; or determine whether to reset the PC adjustment state for the active UL BWP of the CC.

Aspect 3 is the apparatus of any of aspects 1 and 2, where the indication is based on a pre-configuration via high layer signaling.

Aspect 4 is the apparatus of any of aspects 1 to 3, where to configure the PC adjustment state for the active UL BWP of the CC, the at least one processor is configured to: maintain the PC adjustment state for the active UL BWP of the CC.

Aspect 5 is the apparatus of any of aspects 1 to 4, where the indication is received via downlink control information (DCI) or a medium access control (MAC) control element (MAC-CE).

Aspect 6 is the apparatus of any of aspects 1 to 5, where the indication is based on an updated configuration via high layer signaling.

Aspect 7 is the apparatus of any of aspects 1 to 6, where to configure the PC adjustment state for the active UL BWP of the CC, the at least one processor is configured to: reset the PC adjustment state for the active UL BWP of the CC.

Aspect 8 is the apparatus of any of aspects 1 to 7, where the indication is received via radio resource control (RRC) signaling.

Aspect 9 is the apparatus of any of aspects 1 to 8, where the UL beam indication includes at least one of spatial relation information, an UL common transmission configuration indication (TCI) state, or a joint UL and downlink (DL) common TCI state.

Aspect 10 is the apparatus of any of aspects 1 to 9, where the indication corresponds to an update to the one or more PC parameters associated with the UL common TCI state or the joint UL and DL common TCI state.

Aspect 11 is the apparatus of any of aspects 1 to 10, where the UL common TCI state or the joint UL and DL common TCI state is: (1) selected for an UL transmission, (2) activated for a potential UL transmission, or (3) configured for the potential UL transmission.

Aspect 12 is the apparatus of any of aspects 1 to 11, where the one or more PC parameters are: (1) configured in an associated TCI state information element (IE), (2) configured outside of the associated TCI state IE, or (3) configured outside of all TCI state IEs and applied to all TCI states.

Aspect 13 is the apparatus of any of aspects 1 to 12, where the at least one processor is further configured to: reset the PC adjustment state for the active UL BWP of the CC when the one or more PC parameters associated with the UL common TCI state or the joint UL and DL common TCI state are updated.

Aspect 14 is the apparatus of any of aspects 1 to 13, where the one or more PC parameters include at least one of: a target signal-to-noise ratio (SNR) value (P0), a pathloss (PL) compensation factor (alpha), a closed loop index, or a PL reference signal (RS).

Aspect 15 is the apparatus of any of aspects 1 to 14, where the PC adjustment state corresponds to a physical uplink shared channel (PUSCH) PC adjustment state, a physical uplink control channel (PUCCH) PC adjustment state, or a sounding reference signal (SRS) PC adjustment state.

Aspect 16 is the apparatus of any of aspects 1 to 15, where the uplink channel or the uplink signal is a physical uplink shared channel (PUSCH), a physical uplink control channel (PUCCH), a sounding reference signal (SRS), or a physical random access channel (PRACH).

Aspect 17 is the apparatus of any of aspects 1 to 16, further including a transceiver coupled to the at least one processor.

Aspect 18 is a method of wireless communication for implementing any of aspects 1 to 17.

Aspect 19 is an apparatus for wireless communication including means for implementing any of aspects 1 to 17.

Aspect 20 is a computer-readable medium storing computer executable code, where the code when executed by a processor causes the processor to implement any of aspects 1 to 17.

Aspect 21 is an apparatus for wireless communication at a base station including at least one processor coupled to a memory and configured to: transmit, to a user equipment (UE), an indication of at least one of an update to one or more power control (PC) parameters, an update to an uplink (UL) beam indication, or an update to the one or more PC parameters associated with the UL beam indication; and receive, from the UE based on the indication, an uplink channel or an uplink signal based on a power control (PC) adjustment state for an active UL bandwidth part (BWP) of a component carrier (CC).

Aspect 22 is the apparatus of aspect 21, where the PC adjustment state for the active UL BWP of the CC is maintained or reset based on the indication.

Aspect 23 is the apparatus of any of aspects 21 and 22, where the indication is based on a pre-configuration via high layer signaling.

Aspect 24 is the apparatus of any of aspects 21 to 23, where the PC adjustment state for the active UL BWP of the CC is maintained, and where the indication is transmitted via downlink control information (DCI) or a medium access control (MAC) control element (MAC-CE).

Aspect 25 is the apparatus of any of aspects 21 to 24, where the indication is based on an updated configuration via high layer signaling.

Aspect 26 is the apparatus of any of aspects 21 to 25, where the PC adjustment state for the active UL BWP of the CC is reset, and where the indication is transmitted via radio resource control (RRC) signaling.

Aspect 27 is the apparatus of any of aspects 21 to 26, where the UL beam indication includes at least one of spatial relation information, an UL common transmission configuration indication (TCI) state, or a joint UL and downlink (DL) common TCI state.

Aspect 28 is the apparatus of any of aspects 21 to 27, where the indication corresponds to an update to the one or more PC parameters associated with the UL common TCJ state or the joint UL and DL common TCJ state.

Aspect 29 is the apparatus of any of aspects 21 to 28, where the UL common TCJ state or the joint UL and DL common TCJ state is: (1) selected for an UL transmission, (2) activated for a potential UL transmission, or (3) configured for the potential UL transmission.

Aspect 30 is the apparatus of any of aspects 21 to 29, where the one or more PC parameters are: (1) configured in an associated TCJ state information element (IE), (2) configured outside of the associated TCJ state IE, or (3) configured outside of all TCJ state IEs and applied to all TCI states.

Aspect 31 is the apparatus of any of aspects 21 to 30, where the PC adjustment state for the active UL BWP of the CC is reset when the one or more PC parameters associated with the UL common TCI state or the joint UL and DL common TCI state are updated.

Aspect 32 is the apparatus of any of aspects 21 to 31, where the one or more PC parameters include at least one of: a target signal-to-noise ratio (SNR) value (P0), a pathloss (PL) compensation factor (alpha), a closed loop index, or a PL reference signal (RS).

Aspect 33 is the apparatus of any of aspects 21 to 32, where the PC adjustment state corresponds to a physical uplink shared channel (PUSCH) PC adjustment state, a physical uplink control channel (PUCCH) PC adjustment state, or a sounding reference signal (SRS) PC adjustment state.

Aspect 34 is the apparatus of any of aspects 21 to 33, where the uplink channel or the uplink signal is a physical uplink shared channel (PUSCH), a physical uplink control channel (PUCCH), a sounding reference signal (SRS), or a physical random access channel (PRACH).

Aspect 35 is the apparatus of any of aspects 21 to 34, further including a transceiver coupled to the at least one processor.

Aspect 36 is a method of wireless communication for implementing any of aspects 21 to 35.

Aspect 37 is an apparatus for wireless communication including means for implementing any of aspects 21 to 35.

Aspect 38 is a computer-readable medium storing computer executable code, where the code when executed by a processor causes the processor to implement any of aspects 21 to 35.

1. An apparatus for wireless communication at a user equipment (UE), comprising:
a memory; and
at least one processor coupled to the memory and configured to:
receive, from a base station, an indication of at least one of an update to one or more power control (PC) parameters, an update to an uplink (UL) beam indication, or an update to the one or more PC parameters associated with the UL beam indication;
configure, based on the indication, a PC adjustment state for an active UL bandwidth part (BWP) of a component carrier (CC); and
transmit, to the base station, an uplink channel or an uplink signal based on the configured PC adjustment state for the active UL BWP of the CC.

2. The apparatus of claim 1, wherein to configure the PC adjustment state for the active UL BWP of the CC, the at least one processor is configured to:
maintain the PC adjustment state for the active UL BWP of the CC;
reset the PC adjustment state for the active UL BWP of the CC; or
determine whether to reset the PC adjustment state for the active UL BWP of the CC.

3. The apparatus of claim 2, wherein the indication is based on a pre-configuration via high layer signaling.

4. The apparatus of claim 3, wherein to configure the PC adjustment state for the active UL BWP of the CC, the at least one processor is configured to maintain the PC adjustment state for the active UL BWP of the CC.

5. The apparatus of claim 3, wherein the indication is received via downlink control information (DCI) or a medium access control (MAC) control element (MAC-CE).

6. The apparatus of claim 2, wherein the indication is based on an updated configuration via high layer signaling.

7. The apparatus of claim 6, wherein to configure the PC adjustment state for the active UL BWP of the CC, the at least one processor is configured to reset the PC adjustment state for the active UL BWP of the CC.

8. The apparatus of claim 6, wherein the indication is received via radio resource control (RRC) signaling.

9. The apparatus of claim 1, wherein the UL beam indication includes at least one of spatial relation information, an UL common transmission configuration indication (TCI) state, or a joint UL and downlink (DL) common TCI state.

10. The apparatus of claim 9, wherein the indication corresponds to an update to the one or more PC parameters associated with the UL common TCI state or the joint UL and DL common TCI state.

11. The apparatus of claim 10, wherein the UL common TCI state or the joint UL and DL common TCI state is: (1) selected for an UL transmission, (2) activated for a potential UL transmission, or (3) configured for the potential UL transmission.

12. The apparatus of claim 10, wherein the one or more PC parameters are: (1) configured in an associated TCI state information element (IE), (2) configured outside of the associated TCI state IE, or (3) configured outside of all TCI state IEs and applied to all TCI states.

13. The apparatus of claim 10, wherein the at least one processor is further configured to:
reset the PC adjustment state for the active UL BWP of the CC when the one or more PC parameters associated with the UL common TCI state or the joint UL and DL common TCI state are updated.

14. The apparatus of claim 1, wherein the one or more PC parameters include at least one of: a target signal-to-noise ratio (SNR) value (P0), a pathloss (PL) compensation factor (alpha), a closed loop index, or a PL reference signal (RS).

15. The apparatus of claim 1, wherein the PC adjustment state corresponds to a physical uplink shared channel (PUSCH) PC adjustment state, a physical uplink control channel (PUCCH) PC adjustment state, or a sounding reference signal (SRS) PC adjustment state.

16. The apparatus of claim 1, further comprising a transceiver coupled to the at least one processor;
wherein the uplink channel or the uplink signal is a physical uplink shared channel (PUSCH), a physical uplink control channel (PUCCH), a sounding reference signal (SRS), or a physical random access channel (PRACH).

17. A method of wireless communication at a user equipment (UE), comprising:
receiving, from a base station, an indication of at least one of an update to one or more power control (PC) parameters, an update to an uplink (UL) beam indication, or an update to the one or more PC parameters associated with the UL beam indication;
configuring, based on the indication, a PC adjustment state for an active UL bandwidth part (BWP) of a component carrier (CC); and
transmitting, to the base station, an uplink channel or an uplink signal based on the configured PC adjustment state for the active UL BWP of the CC.

18. (canceled)

19. An apparatus for wireless communication at a base station, comprising:
a memory; and
at least one processor coupled to the memory and configured to:
transmit, to a user equipment (UE), an indication of at least one of an update to one or more power control (PC) parameters, an update to an uplink (UL) beam indication, or an update to the one or more PC parameters associated with the UL beam indication; and
receive, from the UE based on the indication, an uplink channel or an uplink signal based on a power control (PC) adjustment state for an active UL bandwidth part (BWP) of a component carrier (CC).

20. The apparatus of claim 19, wherein the PC adjustment state for the active UL BWP of the CC is maintained or reset based on the indication.

21. The apparatus of claim 20, wherein the indication is based on a pre-configuration via high layer signaling.

22. The apparatus of claim 21, wherein the PC adjustment state for the active UL BWP of the CC is maintained, and wherein the indication is transmitted via downlink control information (DCI) or a medium access control (MAC) control element (MAC-CE).

23. The apparatus of claim 20, wherein the indication is based on an updated configuration via high layer signaling.

24. The apparatus of claim 23, wherein the PC adjustment state for the active UL BWP of the CC is reset, and wherein the indication is transmitted via radio resource control (RRC) signaling.

25. The apparatus of claim 19, wherein the UL beam indication includes at least one of spatial relation information, an UL common transmission configuration indication (TCI) state, or a joint UL and downlink (DL) common TCI state.

26. The apparatus of claim 25, wherein the indication corresponds to an update to the one or more PC parameters associated with the UL common TCI state or the joint UL and DL common TCI state.

27. The apparatus of claim 26, wherein the UL common TCI state or the joint UL and DL common TCI state is: (1) selected for an UL transmission, (2) activated for a potential UL transmission, or (3) configured for the potential UL transmission.

28. The apparatus of claim 26, wherein the one or more PC parameters are: (1) configured in an associated TCI state information element (IE), (2) configured outside of the associated TCI state IE, or (3) configured outside of all TCI state IEs and applied to all TCI states.

29. The apparatus of claim 26, wherein the PC adjustment state for the active UL BWP of the CC is reset when the one or more PC parameters associated with the UL common TCI state or the joint UL and DL common TCI state are updated.

30. (canceled)

31. (canceled)

32. The apparatus of claim 19, further comprising a transceiver coupled to the at least one processor;
wherein the uplink channel or the uplink signal is a physical uplink shared channel (PUSCH), a physical uplink control channel (PUCCH), a sounding reference signal (SRS), or a physical random access channel (PRACH).

33. A method of wireless communication at a base station, comprising:
transmitting, to a user equipment (UE), an indication of at least one of an update to one or more power control (PC) parameters, an update to an uplink (UL) beam indication, or an update to the one or more PC parameters associated with the UL beam indication; and
receiving, from the UE based on the indication, an uplink channel or an uplink signal based on a power control (PC) adjustment state for an active UL bandwidth part (BWP) of a component carrier (CC).

34.-42. (canceled)
